(19) United States
(12) Patent Application Publication
(10) Pub. No.: US 2025/0071610 A1
(43) Pub. Date: Feb. 27, 2025

(54) NETWORK INFORMATION EXPOSURE METHOD AND RELATED DEVICE

(71) Applicant: TENCENT TECHNOLOGY (SHENZHEN) COMPANY LTD., Shenzhen (CN)

(72) Inventor: Zhuoyun ZHANG, Shenzhen (CN)

(73) Assignee: TENCENT TECHNOLOGY (SHENZHEN) COMPANY LTD., Shenzhen (CN)

(21) Appl. No.: 18/926,521

(22) Filed: Oct. 25, 2024

Related U.S. Application Data
(63) Continuation of application No. PCT/CN2023/126080, filed on Oct. 24, 2023.

(30) Foreign Application Priority Data
Oct. 26, 2022 (CN) 202211319701.2

(51) Int. Cl. H04W 28/02; H04W 8/20; H04W 8/22

(52) U.S. Cl. CPC H04W 28/0284; H04W 8/20; H04W 8/22

(57) ABSTRACT

A network information exposure method, performed by a core network object, includes: receiving a congestion information exposure request; determining, based on the congestion information exposure request being received, a first congestion information exposure manner of a first network device based on congestion policy configuration information of a second network device; and transmitting a congestion information exposure subscription message of the first network device, wherein the congestion information exposure subscription message includes first information indicating the first congestion information exposure manner.

### CROSS-REFERENCE TO RELATED APPLICATIONS

This application is a continuation application of International Application No. PCT/CN2023/126080 filed on Oct. 24, 2023, which claims priority to Chinese Patent Application No. 202211319701.2, filed with the China National Intellectual Property Administration on Oct. 26, 2022, the disclosures of each being incorporated by reference herein in their entireties.

### FIELD

The present disclosure relates to the field of communication technologies, and to a network information exposure method, a communication device, a computer-readable storage medium, and a computer program product.

### BACKGROUND

FIG. 1 is a schematic diagram of a 5th generation mobile communication technology (5G) network capability exposure architecture. As shown in FIG. 1, a network exposure object (NEO) (sometimes referred to as a “network exposure function” (NEF) by the 3rd Generation Partnership Project (3GPP), for example) interacts with an application object (AO) (sometimes referred to as an “application function” (AF) by the 3GPP, for example) via corresponding application program interfaces (APIs) (such as an API 1, an API 2, an API 3, . . . , and an API n shown in FIG. 1, where n is a positive integer greater than or equal to 1) and an N33 interface, to obtain a capability call request of the AO, and exposes corresponding information to the AO based on the capability call request. The NEO interacts with other network objects (NOs) (sometimes referred to as “network functions” (NFs) by the 3GPP, for example) (such as an NO1, an NO2, . . . , and an NOn shown in FIG. 1, where n is a positive integer greater than or equal to 1) of a 5G core network control plane via service interfaces (such as a 3GPP interface as shown in FIG. 1) to obtain network information used by the AO.

### SUMMARY

Provided are a network information exposure method, a communication device, a computer-readable storage medium, and a computer program product, such that a congestion information exposure manner of a network device may be determined based on capability information of the network device.

According to some embodiments, a network information exposure method includes: receiving a congestion information exposure request; determining, based on the congestion information exposure request being received, a first congestion information exposure manner of a first network device based on congestion policy configuration information of a second network device; and transmitting a congestion information exposure subscription message of the first network device, wherein the congestion information exposure subscription message includes first information indicating the first congestion information exposure manner.

According to some embodiments, a communication device includes: at least one memory configured to store computer program code; at least one processor configured to read the program code and operate as instructed by the program code, the program code comprising: receiving code configured to cause at least one of the at least one processor to receive a congestion information exposure request; determining code configured to cause at least one of the at least one processor to, based on the congestion information exposure request being received, determine a first congestion information exposure manner of a first network device based on congestion policy configuration information of a second network device; and transmitting code configured to cause at least one of the at least one processor to transmit a congestion information exposure subscription message of the first network device, wherein the congestion information exposure subscription message comprises first information configured to indicate the first congestion information exposure manner.

According to some embodiments, a non-transitory computer-readable storage medium, storing computer code which, when executed by at least one processor, causes the at least one processor to at least: receive a congestion information exposure request; determine a first congestion information exposure manner of a first network device based on congestion policy configuration information of a second network device; and transmit a congestion information exposure subscription message of the first network device, wherein the congestion information exposure subscription message comprises first information configured to indicate the first congestion information exposure manner.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a 5G network capability exposure architecture.

FIG. 2 is a flowchart of a network information exposure method according to some embodiments.

FIG. 3 is a flowchart of a network information exposure method according to some embodiments.

FIG. 4 is a flowchart of a network information exposure method according to some embodiments.

FIG. 5 is a schematic diagram of interaction of a network information exposure method according to some embodiments.

FIG. 6 is a flowchart of a network information exposure method according to some embodiments.

FIG. 7 is a flowchart of a network information exposure method according to some embodiments.

FIG. 8 is a flowchart of a network information exposure method according to some embodiments.

FIG. 9 is a block diagram of a policy control object according to some embodiments.

FIG. 10 is a block diagram of a network device according to some embodiments.

FIG. 11 is a block diagram of a target network device according to some embodiments.

FIG. 12 is a block diagram of a user plane object according to some embodiments.

FIG. 13 is a schematic diagram of a structure of a communication device according to some embodiments.

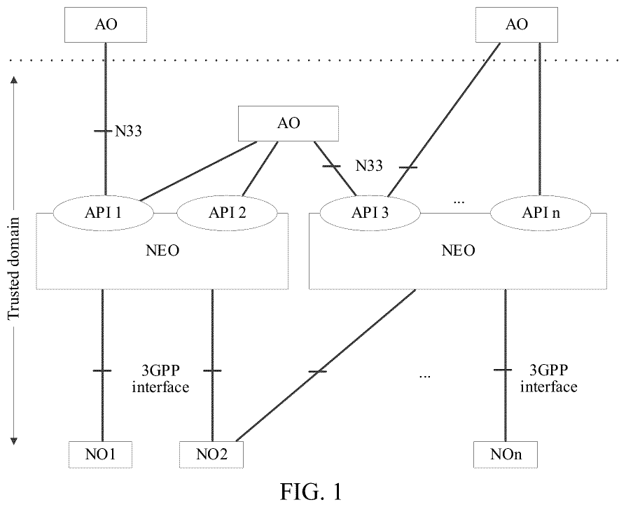

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some embodiments may be applied to various communication systems, such as: a global system for mobile communications (GSM), a code division multiple access (CDMA) system, a wideband code division multiple access (WCDMA) system, a general packet radio service (GPRS) system, a long term evolution (LTE) system, an LTE frequency division duplex (FDD) system, an LTE time division duplex (TDD), a universal mobile telecommunications system (UMTS), a worldwide interoperability for microwave access (WiMAX) communication system, a 5G system, or a future evolved mobile communication system.

The terms “system” and “network” may be used interchangeably herein.

Firstly, some terms involved in some embodiments are explained.
RAN: Radio access network.
AO: Application object (sometimes referred to as an “application function” (AF) by the 3rd Generation Partnership Project (3GPP), for example).
NEO: Network exposure object (sometimes referred to as a “network exposure function” (NEF) by the 3GPP, for example).
UPO: User plane object (sometimes referred to as a “user plane function” (UPF) by the 3GPP, for example).
AMO: Access and mobility management object (sometimes referred to as an “access and mobility management function” (AMF) by the 3GPP, for example).
SMO: Session management object (sometimes referred to as a “session management function” (SMF) by the 3GPP, for example).
PCO: Policy control object (sometimes referred to as a “policy control function” (PCF) by the 3GPP, for example).
UE: User equipment.

“Network capability exposure” and “capability exposure” mentioned in some embodiments refer to abstracting and exposing a capability of a network (such as a 5G network, but is not limited thereto), and may implement intercommunication and cooperation between an operator network and a third-party service provider, and meeting a capability to expose a mobile network to a third party.

The capability exposure supports external exposure of a network capability. Externally exposed service capabilities, for example, may include but are not limited to, as follows.
(1) Network detection capability exposure: Refers to that a network provides a capability to detect a congestion status of an area of the network or detect a movement range of a terminal for a third party, and exposes detection event information to the outside by using an NEO.
(2) Network basic service capability exposure: Refers to that a network provides capabilities such as a basic short message, a voice, and charging for a third party.
(3) Network control capability exposure: Refers to that a network provides a capability to guarantee quality of service (QOS) for the third party.
(4) Network information capability exposure: Refers to that a network provides internal network information including such as a real-time terminal connection attribute, terminal location information, non-real-time big data analysis information, to a third party.
(5) Network slice orchestration and management capability exposure: Refers to that a network exposes a life cycle management capability of a network slice for a third party.
(6) Reverse capability exposure: Refers to that a third party may expose valuable information to a mobile network for network optimization and management, such as a terminal communication mode and mobility information.

In development of a data packet (such as a multimedia data packet) transmission technology, a service server may combine information and a status of network transmission to adapt and adjust a code rate, adjust a video resolution, and the like. Some embodiments provide a network information exposure method that may be applied to expose congestion information in network information and satisfy an application layer processing condition.

In some embodiments, a target terminal may be any terminal, and a target service may be any service on the target terminal. Network information refers to any network-side information related to the target service of the target terminal that the network device can obtain, which may include but is not limited to one or a combination of network-side congestion information, a data transmission rate, a packet loss rate, a bit error rate, and the like.

In some embodiments, congestion information refers to information configured for indicating whether congestion occurs in the network of the target terminal and/or a status based on the congestion occuring (such as a congestion degree or a congestion level), or information configured for indicating whether a transmission channel of the target service of the target terminal is congested and/or a status based on the congestion occurring (such as a congestion degree or a congestion level).

Some manners to expose congestion information of a network device such as a base station are described below.
(1) The base station transmits congestion information to the AMO through an N2 message (the N2 message may include congestion information), the AMO transmits the congestion information to the SMO, and the SMO transmits the congestion information to the PCO. The congestion information may be transmitted to the AO by the PCO. The N2 message in some embodiments refers to a message transmitted on an N2 interface. The N2 interface is an interface between the base station and the AMO. The N2 message may be a message that is already defined in a standard and is transmitted between the base station and the AMO, or may be a newly added message that is transmitted between the base station and the AMO. A name of the N2 message is not limited in some embodiments.
(2) The base station transmits an uplink data packet to the UPO (the uplink data packet may include congestion information), and the uplink data packet is transmitted to the AO by the UPO, or transmitted to the AO by the NEO.
(3) The base station marks an explicit congestion notification (ECN) information (the ECN information may indicate occurrence of congestion) in a header of a data packet, and the data packet is finally transmitted to a service server via a user plane.

According to some embodiments, based on the congestion information exposure manners of the foregoing plurality of base stations existing, the exposure manners may be selected and controlled based on the capability information of the network device.

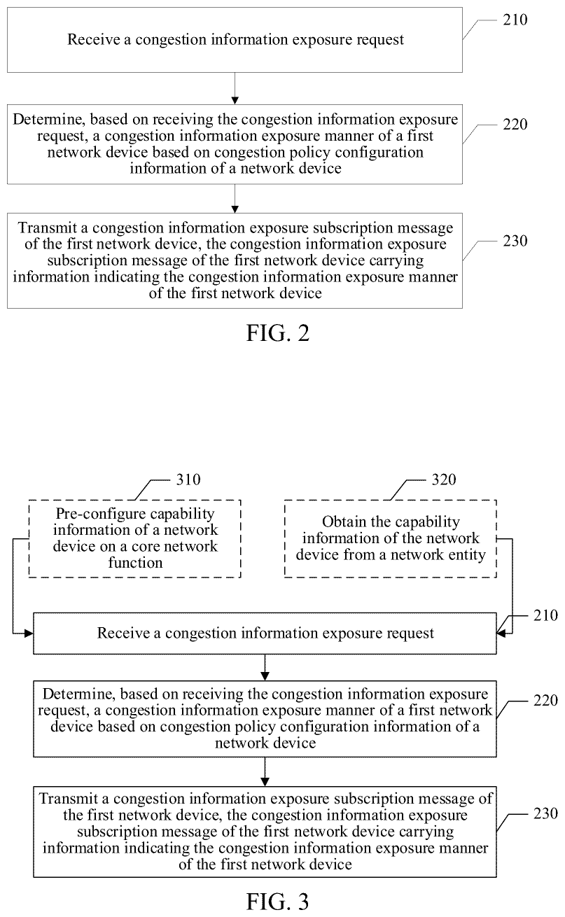

FIG. 2 is a flowchart of a network information exposure method according to some embodiments. The method provided in some embodiments shown in FIG. 2 may be performed by a core network object (or “core network function” by the 3GPP, for example). The core network object may be a policy control object (PCO) (sometimes referred to as a “policy control function” (PCF) by the 3GPP, for example), a session management object (SMO) (sometimes referred to as a “session management function” (SMF) by the 3GPP, for example), or another core network object.

An example in which the core network object is the PCO is used. The following describes some embodiments.

As shown in FIG. 2, the method in some embodiments may include the following operations.

210: Receive a congestion information exposure request.

In some embodiments, the PCO may receive the congestion information exposure request from an AO. The congestion information exposure request refers to a request message transmitted by the AO and configured for requesting congestion information used by the AO. The congestion information exposure request carries user information (such as a user IP address, for example, an IP address of user equipment) and service information (such as a service identifier). The PCO determines a terminal device used by the user based on the user information, to determine a network device connected to the terminal device, and may determine a congestion information exposure manner of the network device based on capability information of the network device. The PCO may further determine, based on the service information, a target service targeted by the congestion information exposure request.

220: Determine, based on receiving the congestion information exposure request, a congestion information exposure manner of a first network device based on congestion policy configuration information of a network device.

In some embodiments, the congestion policy configuration information of the network device includes the capability information of the network device. The capability information of the network device may be configured for indicating a congestion information exposure manner supported by the network device.

In some embodiments, the determining a congestion information exposure manner of a first network device based on congestion policy configuration information of a network device may include: determining the congestion information exposure manner of the first network device based on the capability information of the network device.

In some embodiments, the congestion policy configuration information of the network device further includes an operator policy of the network device and local configuration of the core network object. The operator policy includes a first congestion policy corresponding to the target service. The first congestion policy may be configured for indicating a proportion of the target service using each congestion information exposure manner. For example, for congestion information of the target service, 30% of the congestion information uses the congestion information exposure manner described in the foregoing manner (1), 50% of the congestion information uses the congestion information exposure manner described in the foregoing manner (2), and 20% of the congestion information uses the congestion information exposure manner described in the foregoing manner (3). The local configuration of the core network object includes a second congestion policy. The second congestion policy may be configured for indicating a priority of each congestion information exposure manner. Based on congestion information exposure being performed, a congestion information exposure manner with a high priority may be selected. The determining a congestion information exposure manner of a first network device based on congestion policy configuration information of a network device may include: determining the congestion information exposure manner of the first network device based on the capability information and the operator policy of the network device, and the local configuration of the policy control object.

In some embodiments, based on the PCO receiving the congestion information exposure request transmitted by the AO, the PCO may determine, based on factors such as capability information and an operator policy of the network device such as the base station, and the local configuration, a path and method for exposing the congestion information of the network device. The determined path and method for exposing the congestion information of the network device are referred to as the congestion information exposure manner of the first network device.

In some embodiments, the capability information of the network device refers to capability information about which congestion information the network device to supports.

In some embodiments, the capability information of the network device may include at least one of the following:
whether the network device supports an explicit congestion notification;
whether the network device has a capability of supporting congestion information reporting of a data plane; and
whether the network device supports reporting the congestion information via a notification process.

For example, the capability information of the base station may refer to whether the base station supports the ECN, whether the base station supports the capability of supporting congestion information reporting of a data plane, and whether the base station supports reporting the congestion information via the notification process.

In some embodiments, the information indicating the congestion information exposure manner of the first network device may include at least one of the following:
information instructing the network device to perform explicit congestion notification marking;
information instructing the network device to generate an uplink data packet including congestion information and transmit, via a data plane, the uplink data packet to a user plane object; and
information instructing the network device to report, via a notification path of a control plane, the congestion information.

For example, the PCO may instruct, by using the congestion information exposure manner of the first network device, the base station to use which manner to report the congestion information. For example, the PCO instructs the base station to perform explicit congestion notification (ECN) marking, or the PCO instructs the base station to transmit, via the data plane, a data packet including congestion information (such as the foregoing uplink data packet) to the UPO, or the PCO instructs the base station to report the congestion information via a notification path of a control plane.

230: Transmit a congestion information exposure subscription message of the first network device. The congestion information exposure subscription message of the first network device carries information indicating the congestion information exposure manner of the first network device.

In some embodiments, the transmitting a congestion information exposure subscription message of the first network device may include:
transmitting the congestion information exposure subscription message of the first network device to a session management object to instruct the session management object to transmit the congestion information exposure subscription message of the first network device to an access and mobility management object, the access and mobility management object being configured to transmit the congestion information exposure subscription message of the first network device to the network device through an N2 message; or
transmitting the congestion information exposure subscription message of the first network device to an access and mobility management object to instruct the access and mobility management object to transmit the congestion information exposure manner of the first network device to the network device through an N2 message.

In some embodiments, the congestion information exposure subscription message of the first network device refers to a message transmitted by the PCO and configured for requesting or subscribing information of the network device, such as the base station, reporting the congestion information.

For example, the PCO may instruct the base station, in a message requesting or subscribing the base station, to use which manner (for example, by carrying information indicating the congestion information exposure manner of the first network device in the congestion information exposure subscription message of the first network device) to report the congestion information. The PCO transmits the congestion information exposure subscription message of the first network device to the AMO by using the SMO, or directly transmits the congestion information exposure subscription message of the first network device to the AMO. The AMO transmits the congestion information exposure subscription message of the first network device to the base station through the N2 message.

In some embodiments, the terms “transmit”, “send”, and “receive” may express direct transmitting, sending, and receiving, or indirect transmission, sending, and receiving. For example, the network device may directly or indirectly transmit network information to the AO. “Indirectly” refers to that another network element may be included between the network device and the AO, and the network information is finally forwarded to the AO through forwarding of another network element.

In the network information exposure method provided in some embodiments, the policy control object may determine the congestion information exposure manner of the first network device based on the congestion policy configuration information of the network device, to be configured for responding to the received congestion information exposure request.

FIG. 3 is a flowchart of a network information exposure method according to some embodiments. The method provided in some embodiments in FIG. 3 may be performed by a core network object, but the disclosure is not limited thereto.

As shown in FIG. 3, the method in some embodiments may include the following operations.

In some embodiments, 310: Pre-configure the capability information of the network device on the core network object.

In some embodiments, 320: Obtain the capability information of the network device from a network entity.

In some embodiments, the core network object is a policy control object. The network entity may include at least one of a unified data management entity, a unified data repository entity, a network operation and maintenance system, an access and mobility management object, a session management object, and the like.

210: Receive a congestion information exposure request.

220: Determine, based on receiving the congestion information exposure request, a congestion information exposure manner of a first network device based on congestion policy configuration information of a network device.

230: Transmit a congestion information exposure subscription message of the first network device. The congestion information exposure subscription message of the first network device carries information indicating the congestion information exposure manner of the first network device.

In 230, the PCO may determine the congestion information exposure manner of the first network device based on the capability information of the network device pre-configured on the PCO in 310, or based on the capability information of the network device obtained from the network entity in 320, or based on the capability information and the operator policy of the network device, and the local configuration of the PCO.

In some embodiments, based on the network device supporting a plurality of congestion information exposure manners, the PCO may select one of the plurality of congestion information exposure manners as the congestion information exposure manner of the first network device. The determining a congestion information exposure manner of a first network device based on congestion policy configuration information of a network device may include: determining, based on the capability information of the network device, at least one congestion information exposure manner supported by the network device; and selecting one congestion information exposure manner from the at least one congestion information exposure manner supported by the network device, and determining the congestion information exposure manner as the congestion information exposure manner of the first network device. For example, a congestion information exposure manner of which proportion may not exceed a preset threshold and has a highest priority may be selected, among congestion information exposure manners supported by the network device, as the congestion information exposure manner of the first network device.

According to the network information exposure method provided in some embodiments, the capability information of the network device such as the base station may be pre-configured on the PCO, stored in UDM/UDR, stored in the network operation and maintenance system, or stored on another network entity in a mobile network. The PCO may obtain the capability information of the base station from a corresponding network entity.

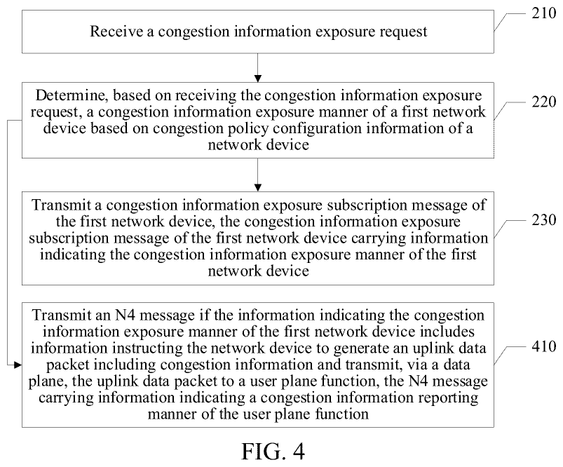

FIG. 4 is a flowchart of a network information exposure method according to some embodiments. The method provided in some embodiments in FIG. 4 may be performed by a policy control object, but the disclosure is not limited thereto.

As shown in FIG. 4, a difference from FIG. 2 is that FIG. 4 further includes 410: Further transmit an N4 message if the information indicating the congestion information exposure manner of the first network device includes information instructing the network device to generate an uplink data packet including congestion information and transmit, via a data plane, the uplink data packet to a user plane object. The N4 message may carry information indicating a congestion information reporting manner of the user plane object.

An execution sequence between 230 and 410 is not limited.

In some embodiments, the information indicating the congestion information reporting manner of the user plane object may include at least one of the following:

information instructing the user plane object to transmit, via an application program interface, the congestion information to a session management object, the session management object being configured to transmit the congestion information to the policy control object, the policy control object being configured to perform a network policy adjustment based on the congestion information or configured to transmit the congestion information to an application object;

information instructing the user plane object to transmit, via the application program interface, the congestion information to the application object; and

information instructing the user plane object to mark an explicit congestion notification of a data packet including the congestion information.

According to the network information exposure method provided in some embodiments, based on a PCO determining that the network device, such as a base station, reports the congestion information to a UPO by using a data packet of a user plane (such as the foregoing uplink data packet), an SMO or the PCO may further instruct the UPO how to report the congestion information (referred to as the congestion information reporting manner of the user plane object). The UPO may include the following reporting manners.

Manner 1: Based on receiving the data packet including the congestion information (such as the uplink data packet) transmitted by the base station, the UPO may transmit the congestion information to the SMO via an API interface, and the SMO may transmit the congestion information to the PCO. The PCO may perform a network policy adjustment based on the congestion information or transmit the congestion information to an AO. The UPO may directly transmit the congestion information to the AO via the API interface.

Manner 2: Based on the UPO receives the data packet including the congestion information transmitted by the base station, the UPO marks ECN information in the data packet. Based on marking the ECN information in the data packet, the UPO transmits the data packet based on a normal data packet transmitting process.

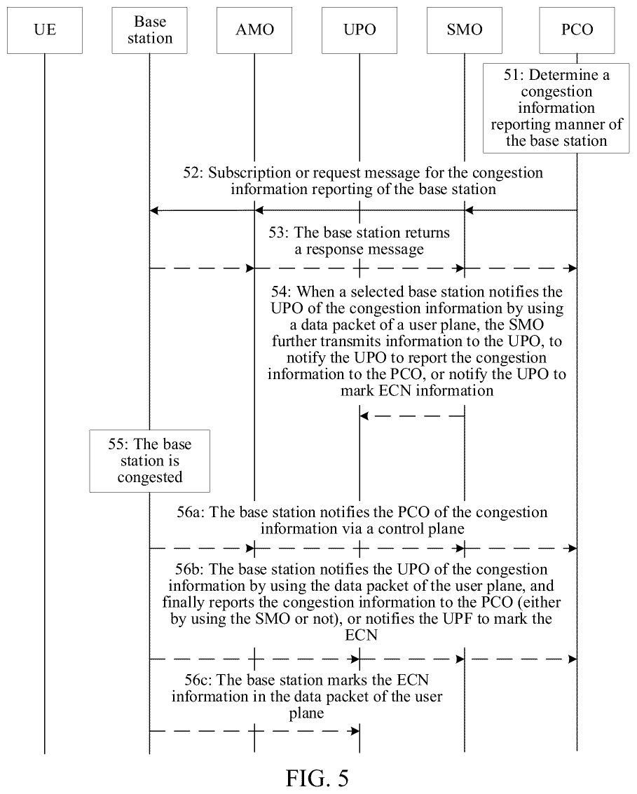

FIG. 5 is a schematic diagram of interaction of a network information exposure method according to some embodiments. In some embodiments of FIG. 5, an example in which a network device is a base station is used for description, but the disclosure is not limited thereto. As shown in FIG. 5, the method in some embodiments may include the following operations.

51: A PCO determines a congestion information reporting manner of the base station.

In some embodiments, based on the PCO receiving a congestion information exposure request transmitted by an AO, and the PCO accepting the congestion information exposure request, the PCO may determine a terminal device (UE) used by a user based on user information carried in the congestion information exposure request. Information such as capability information and an operator policy of the base station to which the UE is connected (for example, the base station to which the UE accesses) may be considered to determine how the base station to which the UE is connected reports the congestion information, and the determined congestion information reporting manner of the base station is referred to as a congestion information exposure manner of a first network device. If the base station supports an explicit congestion notification, has a capability of supporting congestion information reporting of a data plane, and supports reporting the congestion information via a notification process, the PCO may select one of the following three congestion information exposure manners as the congestion information exposure manner of the first network device.

The base station performs explicit congestion notification marking.

The base station generates an uplink data packet including the congestion information and transmit, via the data plane, the uplink data packet to the AO.

The base station reports the congestion information via a notification path of a control plane.

52: The PCO may transmit, by using an SMO and an AMO in sequence, a subscription or request message for the congestion information reporting of the base station to the base station.

In some embodiments, the PCO transmits the subscription or request message for the congestion information reporting to the base station (referred to as a congestion information exposure subscription message of the first network device). In addition to indicating the congestion information reporting manner (for example, the congestion information exposure manner of the first network device determined in 51), the subscription or request message may further indicate a congestion information reporting frequency, a congestion degree reporting threshold, a congestion level, or a congestion degree.

In some embodiments, the PCO may transmit the congestion information exposure subscription message of the first network device to the SMO, and the SMO may transmit the congestion information exposure subscription message of the first network device to the AMO. Finally, the AMO transmits the congestion information exposure subscription message of the first network device to the base station through an N2 message. The PCO may transmit the congestion information exposure subscription message of the first network device to the AMO, and the AMO transmits the congestion information exposure subscription message of the first network device to base station through an N2 message. A path for transmitting the congestion information exposure subscription message of the first network device to the base station is not limited thereto.

In some embodiments, 53: The base station may return a response message to the PCO by using the AMO and the SMO in sequence.

In some embodiments, the base station may return the response message to the PCO based on capability information of the base station.

In some embodiments, 54: Based on a selected base station notifying the UPO of the congestion information by using a data packet of a user plane, the SMO may further transmit information to the UPO, to notify the UPO to report the congestion information to the PCO, or notify the UPO to mark ECN information.

In some embodiments, based on the PCO determining that the base station reports the congestion information to the UPO by using the data packet of the user plane, the SMO or the PCO may further instruct the UPO how to report the congestion information, and the information instructing the UPO how to report the congestion information is referred to as a congestion information reporting manner of a user plane object.

55: The base station is congested.

In some embodiments, based on detecting that the congestion occurs, the base station may report the congestion information based on the congestion information reporting manner (for example, the foregoing congestion information exposure manner the first network device). For example, one of the following manners 56a, 56b, and 56c may be used to report the congestion information.

In some embodiments, 56a: The base station may notify the PCO of the congestion information via the control plane.

In some embodiments, the base station may notify the AMO of the congestion information via the control plane and finally transmit the congestion information to the PCO. For example, the base station may notify the PCO of the congestion information by using the AMO and the SMO in sequence.

In some embodiments, 56b: The base station may notify the UPO of the congestion information by using the data packet of the user plane (the uplink data packet including the congestion information), and finally report the congestion information to the PCO (either by using the SMO or not), or notify the UPO to mark the ECN.

In some embodiments, the base station may transmit the congestion information to the UPO by using the data packet of the user plane, and the UPO reports the congestion information based on the congestion information reporting manner of the user plane object received in 54.

The base station may notify the PCO of the congestion information by using the UPO and the SMO in sequence.

In some embodiments, 56c: The base station may mark the ECN information in the data packet of the user plane. The base station may transmit the data packet with the marked ECN information (such as the uplink data packet) to the UPO.

According to the network information exposure method provided in some embodiments, the congestion information reporting manner of the base station is controlled based on congestion policy configuration information of the base station. Based on the AO receiving the congestion information exposed by the base station to outside, a service server may combine the received congestion information to adapt and adjust a code rate, adjust a video resolution, and the like, to satisfy an application layer processing condition.

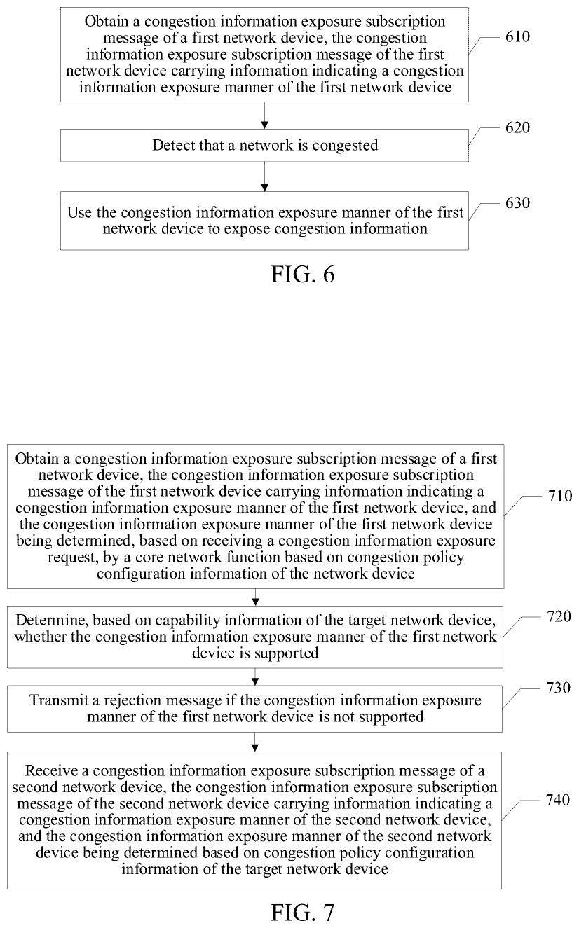

FIG. 6 is a flowchart of a network information exposure method according to some embodiments. The method provided in some embodiments in FIG. 6 may be performed by a network device, and the network device may be a base station.

As shown in FIG. 6, the method in some embodiments may include the following operations.

610: Obtain a congestion information exposure subscription message of a first network device, the congestion information exposure subscription message of the first network device carrying information indicating a congestion information exposure manner of the first network device.

In some embodiments, the congestion information exposure manner of the first network device is determined, based on receiving a congestion information exposure request, by a core network object (such as a PCO) based on congestion policy configuration information of the network device. The congestion information exposure request is transmitted by an AO, and carries user information and service information. The core network object may determine a terminal device used by the user based on the user information, to determine a network device connected to the terminal device, and may determine a congestion information exposure manner of the network device (for example, the congestion information exposure manner of the first network device) based on capability information of the network device. The core network object may further determine, based on the service information, a target service targeted by the congestion information exposure request.

620: Detect that a network is congested.

630: Use the congestion information exposure manner of the first network device to expose congestion information.

In some embodiments, the using the congestion information exposure manner of the first network device to expose congestion information may include: marking explicit congestion notification information in a data packet if the information indicating the congestion information exposure manner of the first network device includes information instructing the network device to perform explicit congestion notification marking.

Based on the PCO determining that the network device such as the base station marks a data packet of a user plane by using an explicit congestion notification, the PCO or an SMO may further instruct a UPO how to report the congestion information. The UPO may include the following reporting manners.

Manner 1: Based on receiving the data packet including the explicit congestion notification mark transmitted by the network device, the UPO may transmit the congestion information to the SMO via an API interface, and the SMO may transmit the congestion information to the PCO. The PCO may finally use the congestion information to perform a network policy adjustment or transmit the congestion information to the AO. The UPO may directly transmit the congestion information to the AO via the API interface.

Manner 2: Based on the UPO receiving the data packet including the explicit congestion notification marking transmitted by the network device, the UPO directly forwards the data packet to the outside without performing any processing on the data packet. If the manner 2 is used, the PCO or the SMO may not perform further instructions on the UPO, and the UPO may not detect whether the data packet includes the data packet including the explicit congestion notification mark, and may forward the data packet directly.

In some embodiments, the using the congestion information exposure manner of the first network device to expose congestion information may include: generating, if the information indicating the congestion information exposure manner of the first network device includes information instructing the network device to generate an uplink data packet including the congestion information and transmit, via a data plane, the uplink data packet including the congestion information to a user plane object, an uplink data packet including the congestion information and transmit the uplink data packet to the user plane object to instruct the user plane object to transmit, via an application program interface, the congestion information to an application object.

In some embodiments, the using the congestion information exposure manner of the first network device to expose congestion information may include: transmitting, if the information indicating the congestion information exposure manner of the first network device includes information instructing the network device to report the congestion information via a notification path of a control plane, the congestion information to an access and mobility management object to instruct the access and mobility management object to transmit the congestion information to a policy control object. The policy control object may be configured to perform a network policy adjustment based on the congestion information or configured to transmit the congestion information to an application object.

In some embodiments, the network device connected to the terminal device may be switched. The network device before switching is referred to as a source network device, and the network device is referred to as a target network device after the switching. The method may further include: Based on the network device connected to the terminal device being switched from the source network device to the target network device, the source network device may transmit the congestion information exposure subscription message of the first network device to the target network device.

In some embodiments, the source network device includes a source base station, and the target network device includes a target base station. For example, if the base station connected to UE is switched, for example, switched from the source base station to the target base station, the source base station may transmit the previously received congestion information reporting request or subscription message (for example, the foregoing congestion information exposure subscription message of the first network device) to the target base station. The target base station may select, based on reporting capability information (for example, capability information of the target network device), whether to accept the congestion information reporting request or subscription message. If the target base station does not support a reporting manner carried in the congestion information reporting request or subscription message (for example, the congestion information exposure manner of the first network device), the target base station transmits a rejection message to the source base station or the AMO, and finally transmits the rejection message to the PCO. The PCO re-determines a congestion information reporting manner (referred to as a congestion information exposure manner of a second network device) based on the congestion policy configuration information of the target base station, and transmits the congestion information reporting manner to the target base station. If the target base station may support the congestion information exposure manner of the second network device, the target base station accepts the congestion information reporting request or subscription message.

Other content in some embodiments in FIG. 6 may refer to the foregoing descriptions.

FIG. 7 is a flowchart of a network information exposure method according to some embodiments. The method provided in some embodiments in FIG. 7 may be performed by a target network device, but the disclosure is not limited thereto.

As shown in FIG. 7, the method in some embodiments may include the following operations.

710: Obtain a congestion information exposure subscription message of a first network device, the congestion information exposure subscription message of the first network device carrying information indicating a congestion information exposure manner of the first network device, and the congestion information exposure manner of the first network device being determined, based on receiving a congestion information exposure request, by a core network object based on congestion policy configuration information of the network device.

720: Determine, based on capability information of the target network device, whether the congestion information exposure manner of the first network device is supported.

730: Transmit a rejection message if the congestion information exposure manner of the first network device is not supported.

740: Receive a congestion information exposure subscription message of a second network device, the congestion information exposure subscription message of the second network device including information indicating a congestion information exposure manner of the second network device, and the congestion information exposure manner of the second network device being determined based on congestion policy configuration information of the target network device.

Other content in some embodiments in FIG. 7 may refer to the foregoing descriptions.

FIG. 8 is a flowchart of a network information exposure method according to some embodiments. The method provided in some embodiments in FIG. 8 may be performed by a user plane object, but the disclosure is not limited thereto.

As shown in FIG. 8, the method in some embodiments may include the following operations.

810: Receive an N4 message, the N4 message carrying information indicating a congestion information reporting manner of the user plane object.

In some embodiments, the N4 message is a message transmitted on an N4 interface. The N4 interface is an interface between an SMO and a UPO. The N4 message may be a message that is already defined in a standard and is transmitted between the SMO and the UPO, or may be a newly added message that is transmitted between the SMO and the UPO. A name of the N4 message is not limited.

In some embodiments, the N4 message is transmitted based on a core network object determining, based on receiving a congestion information exposure request, a congestion information exposure manner of a first network device based on congestion policy configuration information of a network device, and determines that information indicating the congestion information exposure manner of the first network device includes information instructing the network device to generate an uplink data packet including congestion information and transmit, via a data plane, the uplink data packet to the user plane object. The congestion information exposure request is transmitted by an AO and carries user information and service information. The core network object may determine a terminal device used by the user based on the user information, to determine a network device connected to the terminal device, and may determine a congestion information exposure manner of the network device (for example, the congestion information exposure manner of the first network device) based on capability information of the network device. The core network object may further determine, based on the service information, a target service targeted by the congestion information exposure request.

820: Receive the congestion information.

830: Transmit the congestion information by using the congestion information reporting manner of the user plane object.

In some embodiments, the transmitting the congestion information by using the congestion information reporting manner of the user plane object may include:
transmitting, if the congestion information reporting manner of the user plane object includes information instructing the user plane object to transmit, via an application program interface, the congestion information to a session management object network element, the congestion information to the session management object to instruct the session management object to transmit the congestion information to a policy control object, the policy control object being configured to perform a network policy adjustment based on the congestion information or configured to transmit the congestion information to an application object;
transmitting, if the congestion information reporting manner of the user plane object includes information instructing the user plane object to transmit, via an application program interface, the congestion information to an application object, the congestion information to the application object via the application program interface; and
marking, if the congestion information reporting manner of the user plane object includes information indicating the user plane object to mark an explicit congestion notification of a data packet, the explicit congestion notification of the data packet, and transmitting the marked explicit congestion notification of the data packet to a destination server of the data packet.

Other content in some embodiments in FIG. 8 may refer to the foregoing descriptions.

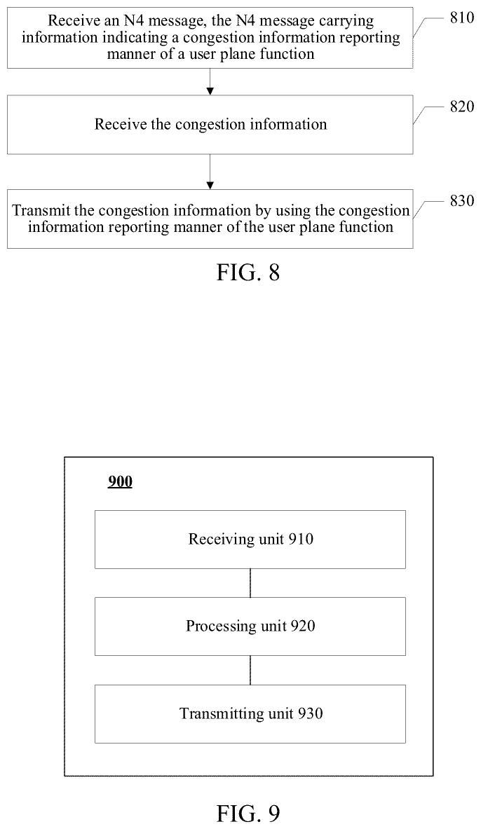

FIG. 9 is a block diagram of a core network object according to some embodiments. The core network object 900 provided in some embodiments in FIG. 9 may include a receiving unit 910, a processing unit 920, and a transmitting unit 930.

The receiving unit 910 may be configured to receive a congestion information exposure request.

The processing unit 920 may be configured to determine, based on the congestion information exposure request being received, a congestion information exposure manner of a first network device based on congestion policy configuration information of the network device.

The transmitting unit 930 may be configured to transmit a congestion information exposure subscription message of the first network device. The congestion information exposure subscription message of the first network device carries information indicating the congestion information exposure manner of the first network device.

Other content in some embodiments shown in FIG. 9 may refer to the foregoing descriptions.

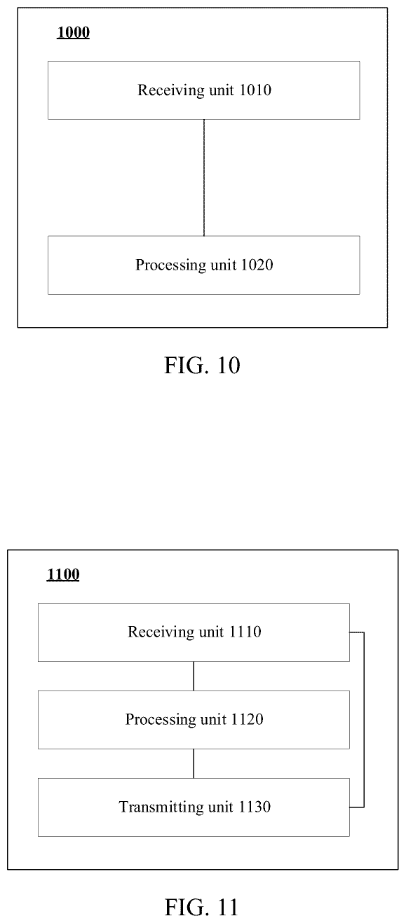

FIG. 10 is a block diagram of a network device according to some embodiments. The network device 1000 provided in some embodiments in FIG. 10 may include a receiving unit 1010 and a processing unit 1020.

The receiving unit 1010 may be configured to obtain a congestion information exposure subscription message of a first network device. The congestion information exposure subscription message of the first network device carries information indicating a congestion information exposure manner of the first network device.

The processing unit 1020 may be configured to detect that a network is congested.

The processing unit 1020 may be further configured to use the congestion information exposure manner of the first network device to expose congestion information.

Other content in some embodiments shown in FIG. 10 may refer to the foregoing descriptions.

FIG. 11 is a block diagram of a target network device according to some embodiments. The target network device 1100 provided in some embodiments in FIG. 11 may include a receiving unit 1110, a processing unit 1120, and a transmitting unit 1130.

The receiving unit 1110 may be configured to obtain a congestion information exposure subscription message of a first network device. The congestion information exposure subscription message of the first network device carries information indicating a congestion information exposure manner of the first network device.

The processing unit 1120 may be configured to determine, based on capability information of the target network device, whether the congestion information exposure manner of the first network device is supported.

The transmitting unit 1130 may be configured to transmit a rejection message if the congestion information exposure manner of the first network device is not supported.

The receiving unit 1110 may be further configured to receive a congestion information exposure subscription message of a second network device. The congestion information exposure subscription message of the second network device carries information indicating a congestion information exposure manner of the second network device. The congestion information exposure manner of the second network device is determined based on congestion policy configuration information of the target network device.

Other content in some embodiments in FIG. 11 may refer to the foregoing descriptions.

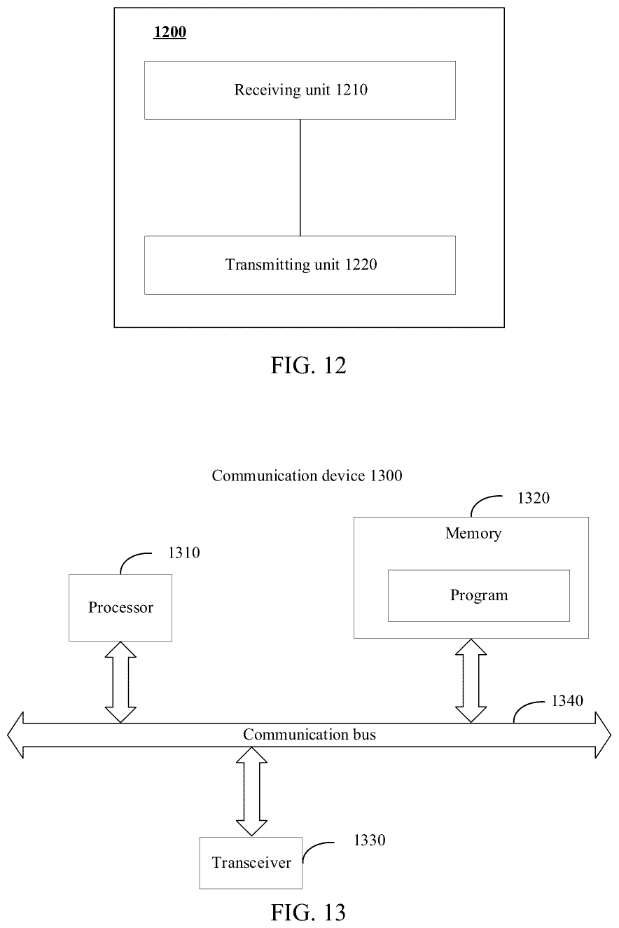

FIG. 12 is a block diagram of a user plane object according to some embodiments. The user plane object 1200 provided in some embodiments in FIG. 12 may include a receiving unit 1210 and a transmitting unit 1220.

The receiving unit 1210 may be configured to receive an N4 message. The N4 message carries information indicating a congestion information reporting manner of the user plane object. The N4 message is transmitted based on a core network object determining, based on receiving a congestion information exposure request, a congestion information exposure manner of a first network device based on congestion policy configuration information of a network device, and determines that information indicating the congestion information exposure manner of the first network device includes information instructing the network device to generate an uplink data packet including congestion information and transmit, via a data plane, the uplink data packet to the user plane object.

The receiving unit 1210 may be further configured to receive the congestion information.

The transmitting unit 1220 may be further configured to transmit the congestion information by using the congestion information reporting manner of the user plane object.

Other content in some embodiments in FIG. 12 may refer to the foregoing descriptions.

FIG. 13 is a schematic diagram of a structure of a communication device 1300 according to some embodiments. The communication device may be a terminal such as UE, a network device such as a base station, or an NEO, an AO, a PCO, an SMO, a UPO, an AMO, and/or the like. The communication device 1300 shown in FIG. 13 includes a processor 1310, and the processor 1310 may call and run a computer program from a memory to implement the method in some embodiments.

As shown in FIG. 13, the communication device 1300 may include a memory 1320. The processor 1310 may call and run a computer program from the memory 1320 to implement the method in some embodiments.

The memory 1320 may be a separate component independent of the processor 1310, or may be integrated into the processor 1310.

As shown in FIG. 13, the communication device 1300 may further include a transceiver 1330, and the processor 1310 may control the transceiver 1330 to communicate with another device. The processor 1310 may transmit information or data to another device or receive information or data from another device.

The transceiver 1330 may include a transmitter and a receiver. The transceiver 1330 may further include an antenna, and there may be one or more antennas.

As shown in FIG. 13, the processor 1310, the memory 1320, and the transceiver 1330 may communicate with each other via a communication bus 1340.

The communication device 1300 may include various network elements in some embodiments, and the communication device 1300 may implement corresponding processes implemented by each network element in various methods in some embodiments.

The communication device 1300 may be various network devices in some embodiments, and the communication device 1300 may implement corresponding processes implemented by each network device in various methods in some embodiments.

The processor in some embodiments may be an integrated circuit chip and may have a signal processing capability. In an implementation process, operations in the method according to some embodiments may be implemented by using a hardware integrated logic circuit in the processor or instructions in the form of software.

The processor may include a digital signal processor (DSP), an application specific integrated circuit (ASIC), a field-programmable gate array (FPGA), or another programmable logic device, a discrete gate or transistor logic device, and a discrete hardware component. The methods, operations, and logic block diagrams that are disclosed in some embodiments may be implemented or performed. The processor may include a microprocessor, or the like. The operations of the methods disclosed with reference to some embodiments may be directly performed and completed by using a hardware decoding processor, or may be performed and completed by using a combination of hardware and software modules in the decoding processor. The software module may be located in a storage medium, such as a random access memory, a flash memory, a read-only memory, a programmable read-only memory, an electrically erasable programmable memory, or a register. The storage medium is located in the memory. The processor reads information in the memory and completes the operations of the methods in combination with hardware thereof.

The memory in some embodiments may be a volatile memory or a non-volatile memory, or may include both a volatile memory and a non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM) serving as an external cache. Through illustrative but not limited description, RAMs in many forms, for example, a static RAM (SRAM), a Dynamic RAM (DRAM), a synchronous DRAM (SDRAM), a double data rate SDRAM (DDR SDRAM), an enhanced SDRAM (ESDRAM), a synchlinkDRAM (SLDRAM), and a direct rambus RAM (DRRAM), are available. The memories of the system and the method described herein are intended to include but are not limited thereto.

According to some embodiments, each object, function, or unit may exist respectively or be combined into one or more units. Some objects, functions, or units may be further split into multiple smaller function subunits, thereby implementing the same operations without affecting the technical effects. The objects, functions, or units are divided based on logical functions. A function of one object, function, or unit may be realized by multiple units, or functions of multiple objects, functions, or units may be realized by one unit. In some embodiments, the apparatus may further include other objects, functions, or units. These functions may also be realized cooperatively by the other objects, functions, or units, and may be realized cooperatively by multiple objects, functions, or units.

A person skilled in the art would understand that these “objects,” “functions,” or “units” could be implemented by hardware logic, a processor or processors executing computer software code, or a combination of both. The “objects,” “functions,” or “units” may also be implemented in software stored in a memory of a computer or a non-transitory computer-readable medium, where the instructions of each unit are executable by a processor to thereby cause the processor to perform the respective operations of the corresponding unit.

Some embodiments provide a computer-readable storage medium for storing a computer program.

The computer-readable storage medium may be used in the network device in some embodiments, and the computer program enables a computer to perform corresponding processes implemented by the network device in various methods of some embodiments.

The computer-readable storage medium may also be used in various network elements in some embodiments, and the computer program enables a computer to perform corresponding processes implemented by the network elements in various methods of the some embodiments.

Some embodiments provide a computer program product, including computer program instructions.

The computer program product may be used in the network device in some embodiments, and the computer program instructions enable a computer to perform corresponding processes implemented by the network device in various methods of some embodiments.

The computer program product may also be used in various network elements in some embodiments, and the computer program instructions enable a computer to perform corresponding processes implemented by the network elements in various methods of the some embodiments.

Some embodiments provide a computer program.

The computer program may be used in the network device in some embodiments, and the computer program, when run on a computer, enables a computer to perform corresponding processes implemented by the network device or the network elements in various methods of some embodiments.

A person skilled in the art may clearly understand that, for clear description, for work processes of the foregoing described system, apparatus, and unit, according to some embodiments, reference may be made to corresponding process in the foregoing method according to some embodiments.

Some embodiments may be implemented in the form of a software product. The computer software product is stored in a storage medium and includes several instructions for instructing a computer device (which may be a personal computer, a server, a network device, or the like) to perform all or some of the operations of the methods described in some embodiments. The foregoing storage medium includes any medium that may store program code, such as a USB flash drive, a removable hard disk, a read-only memory (ROM), a random access memory (RAM), a magnetic disk, and an optical disc.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A network information exposure method, performed by a core network object, the method comprising:
receiving a congestion information exposure request;
determining, based on the congestion information exposure request being received, a first congestion information exposure manner of a first network device based on congestion policy configuration information of a second network device; and
transmitting a congestion information exposure subscription message of the first network device,
wherein the congestion information exposure subscription message includes first information indicating the first congestion information exposure manner.

2. The method according to claim 1, wherein the congestion policy configuration information includes second capability information of the second network device,
wherein the second capability information indicates a second congestion information exposure manner supported by the second network device, and
wherein the determining the first congestion information exposure manner comprises determining the first congestion information exposure manner based on the second capability information.

3. The method according to claim 1, wherein the congestion policy configuration information includes: second capability information of the second network device, a second operator policy of the second network device, and local configuration of the core network object, and
wherein the determining the first congestion information exposure manner comprises determining the first congestion information exposure manner based on the second capability information, the second operator policy, and the local configuration of the core network object.

4. The method according to claim 2, further comprising:
pre-configuring the second capability information on the core network object.

5. The method according to claim 2, further comprising:
obtaining the second capability information from a network entity.

6. The method according to claim 5, wherein the core network object is a policy control object, and
wherein the network entity includes at least one of a unified data management entity, a unified data repository entity, a network operation and maintenance system, an access and mobility management object, or a session management object.

7. The method according to claim 1, wherein the congestion policy configuration information includes second capability information of the second network device, and
wherein the determining the first congestion information exposure manner comprises:
determining, based on the second capability information, at least one congestion information exposure manner supported by the second network device;
selecting one congestion information exposure manner from the at least one congestion information exposure manner supported by the second network device; and
determining the selected congestion information exposure manner as the first congestion information exposure manner.

8. The method according to claim 7, wherein the second capability information indicates at least one of:
whether the second network device supports an explicit congestion notification,
whether the second network device includes a capability of supporting congestion information reporting of a data plane, or
whether the second network device supports reporting the congestion information via a notification process.

9. The method according to claim 7, wherein the first information includes at least one of:
second information instructing the second network device to perform explicit congestion notification marking,
third information instructing the second network device to generate an uplink data packet including congestion information and transmit, via a data plane, the uplink data packet to a user plane object, or
fourth information instructing the second network device to report, via a notification path of a control plane, the congestion information.

10. The method according to claim 7, wherein based on the first information including third information instructing the second network device to generate an uplink data packet including congestion information and transmit, via a data plane, the uplink data packet to a user plane object, the method further comprises:
transmitting an N4 message, and
wherein the N4 message includes fifth information indicating a congestion information reporting manner of the user plane object.

11. A communication device, comprising:
at least one memory configured to store computer program code;
at least one processor configured to read the program code and operate as instructed by the program code, the program code comprising:
receiving code configured to cause at least one of the at least one processor to receive a congestion information exposure request;
determining code configured to cause at least one of the at least one processor to, based on the congestion information exposure request being received, determine a first congestion information exposure manner of a first network device based on congestion policy configuration information of a second network device; and
transmitting code configured to cause at least one of the at least one processor to transmit a congestion information exposure subscription message of the first network device,
wherein the congestion information exposure subscription message comprises first information configured to indicate the first congestion information exposure manner.

12. The communication device according to claim 11, wherein the congestion policy configuration information comprises second capability information of the second network device,
wherein the second capability information indicates a second congestion information exposure manner supported by the second network device, and
wherein the determining code is configured to cause at least one of the at least one processor to determine the first congestion information exposure manner based on the second capability information.

13. The communication device according to claim 11, wherein the congestion policy configuration information comprises:
second capability information of the second network device;
a second operator policy of the second network device; and
local configuration of a core network object, and
wherein the determining code is configured to cause at least one of the at least one processor to determine the first congestion information exposure manner based on the second capability information, the second operator policy, and the local configuration of the core network object.

14. The communication device according to claim 12, further comprising:
pre-configuring code configured to cause at least one of the at least one processor to pre-configure the second capability information on a core network object.

15. The communication device according to claim 12, further comprising:
obtaining code configured to cause at least one of the at least one processor to obtain the second capability information from a network entity.

16. The communication device according to claim 15, wherein the communication device is a policy control object, and
wherein the network entity comprises at least one of:
a unified data management entity;
a unified data repository entity;
a network operation and maintenance system;
an access and mobility management object; or
a session management object.

17. The communication device according to claim 11, wherein the congestion policy configuration information comprises second capability information of the second network device, and
wherein the determining code is configured to cause at least one of the at least one processor to:
determine, based on the second capability information, at least one congestion information exposure manner supported by the second network device;
select one congestion information exposure manner from the at least one congestion information exposure manner supported by the second network device; and
determine the selected congestion information exposure manner as the first congestion information exposure manner.

18. The communication device according to claim 17, wherein the second capability information is configured to indicate at least one of:
whether the second network device supports an explicit congestion notification;
whether the second network device includes a capability of supporting congestion information reporting of a data plane; or
whether the second network device supports reporting the congestion information via a notification process.

19. The communication device according to claim 17, wherein the first information comprises at least one of:
second information instructing the second network device to perform explicit congestion notification marking;
third information instructing the second network device to generate an uplink data packet comprising congestion information and transmit, via a data plane, the uplink data packet to a user plane object; or
fourth information instructing the second network device to report, via a notification path of a control plane, the congestion information.

20. A non-transitory computer-readable storage medium, storing computer code which, when executed by at least one processor, causes the at least one processor to at least:
receive a congestion information exposure request;
determine a first congestion information exposure manner of a first network device based on congestion policy configuration information of a second network device; and
transmit a congestion information exposure subscription message of the first network device,
wherein the congestion information exposure subscription message comprises first information configured to indicate the first congestion information exposure manner.
